(19) United States
(12) Patent Application Publication
(10) Pub. No.: US 2024/0315161 A1
(43) Pub. Date: Sep. 26, 2024

(54) VEHICLE FOR TENDING TO AGRICULTURE AND RELATED METHODS

(71) Applicant: Cruiser Products, LLC, St. Henry, OH (US)

(72) Inventors: Michael T. McCain, Fort Recovery, OH (US); Craig Rauh, Fort Recovery, OH (US)

(21) Appl. No.: 18/735,382

(22) Filed: Jun. 6, 2024

Related U.S. Application Data
(63) Continuation of application No. 17/023,727, filed on Sep. 17, 2020.
(60) Provisional application No. 62/902,042, filed on Sep. 18, 2019.

(51) Int. Cl. A01B 75/00; B60P 1/04; B66F 11/04; B66F 17/00

(52) U.S. Cl. CPC A01B 75/00; B60P 1/04; B66F 11/042; B66F 17/006

(57) ABSTRACT

A vehicle for tending to an elevated agriculture includes a base, a lower platform positioned above the base, and an adjustable support frame extending vertically upward from the lower platform. The adjustable support frame includes an expandable scissor portion. The vehicle also includes an elevated platform connected to the adjustable support frame such that the elevated platform is positioned above the lower platform, the elevated platform configured to selectively, vertically raise upward relative to the base from a lower height toward a higher height via selective expansion of the expandable scissor portion. The vehicle also includes a guide rail extending vertically upward from the elevated platform and horizontally surrounding at least a portion of the elevated platform. The vehicle further includes a drive unit operatively attached to the base and configured to selectively direct horizontal movement of the base with the elevated platform thereon.

### CROSS-REFERENCE TO RELATED APPLICATION

This application claims priority to U.S. patent application Ser. No. 17/023,727, entitled “Vehicle for Tending to Agriculture and Related Methods,” filed Sep. 17, 2020, which claims priority to U.S. Provisional Patent App. No. 62/902,042, entitled “Lift Vehicle for Tending to Agriculture,” filed Sep. 18, 2019, the disclosure of which is incorporated by reference herein.

### TECHNICAL FIELD

The present invention relates generally to a vehicle and method for tending to agriculture in an agricultural facility, and, more particularly, to a vehicle with an elevated platform for tending to elevated livestock in a confinement facility and/or elevated crops in a horticultural facility.

### BACKGROUND

Generally, livestock confinement facilities and indoor horticultural facilities provide for increased livestock and crop production with greater efficiency than traditional agricultural facilities. In fact, for decades, many farmers have specifically selected confinement facilities in order to improve livestock health, increase livestock growth rates, and reduce production costs to generate cost savings from farmers to consumers. However, increased competition within the agricultural industry has decreased profit margins, resulting in the necessity for larger confinement facilities housing increased densities of agriculture per square foot.

In one example, modern poultry confinement facilities extend along a farm for hundreds of yards with similarly long, narrow aisles for maximizing poultry density within the confinement facility. Each aisle provides access to elevated livestock cages, such as poultry cages, arranged in rows and columns along generally the entire length of the confinement facility. Rather than reduce the amount of space for each animal to increase livestock density, farmers are more likely to increase the vertical stacking height of the elevated poultry cages. For example, elevated poultry cages may range in height from eight feet or more from the floor of the confinement facility. Thus, each animal receives enough space for proper health and growth rates while increasing the number of animals within the confinement facility.

In another example, modern horticultural facilities have similar economic constraints as livestock confinement facilities. Crops may be produced in accordance with vertical farming techniques, wherein crops are produced in vertically stacked layers. Vertical farming can be performed outdoors or indoors using controlled-environment agriculture technology.

While increasing the vertical height of elevated livestock cages and elevated crop layers may help increase profit margins, the maintenance associated with elevated agriculture currently tends to reduce these profits. The labor associated with inspecting, maintaining, and cleaning livestock cages, medically treating, feeding, and watering livestock, and/or watering, fertilizing, and weeding elevated crop layers is generally referred to as “tending” to the agriculture. On one hand, a farm operator on foot may simply and efficiently tend to agriculture within easy reach from the aisle. On the other hand, tending to the agriculture within higher elevated livestock cages and elevated crop layers complicates even simple tasks, which increases time, expense, and burden on the farm operator.

For example, every elevated poultry cage is routinely inspected and cleaned while tending to the livestock. Typically, the farm operator inspects and cleans each elevated livestock cage by one of two known methods. For the first method, the farm operator walks along the aisle with a ladder, stopping at each column of elevated livestock cages. The farm operator places the ladder within the aisle and manually climbs the ladder to inspect and clean each cage. Once every livestock cage in the stacked column is clean, the farm operator moves the ladder over several feet and repeats this process for each side of the aisle along the length of the confinement facility. Unfortunately, this method is inefficient, tedious, and extremely time consuming. According to the second method, the farm operator inspects and cleans each livestock cage within reach of the aisle while on foot. Then, the farm operator uses stilts to walk back and forth along the entire length of the aisle while inspecting and cleaning each elevated cage. Despite being more efficient, stilt walking requires considerably more skill and often results in muscular exhaustion due to the need for regular tending of the livestock. As such, the physical labor required to use stilts for tending to elevated livestock cages is often difficult to find and retain.

There is a need for a vehicle and method for tending to elevated livestock cages in a confinement facility, particularly elevated poultry cages, and/or for tending to elevated crops in an indoor horticultural facility that addresses present challenges and characteristics such as those discussed above.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1A is a front perspective view of an exemplary vehicle for tending to agriculture, showing a variable-height elevated platform of the vehicle in a lower height position;

FIG. 1B is a front perspective view of the vehicle similar to FIG. 1A, showing the variable-height elevated platform of the vehicle in an upper height position;

FIG. 2A is a front perspective view of another exemplary vehicle for tending to agriculture, showing a pivotable bucket of the vehicle in an upped orientation;

FIG. 2B is a front perspective view of the vehicle similar to FIG. 2A, showing the pivotable bucket of the vehicle in a dumped orientation; and

FIG. 3 is a front perspective view of another exemplary vehicle for tending to agriculture and having a variable-height elevated platform similar to that shown in FIGS. 1A and 1B and a pivotable bucket similar to that shown in FIGS. 2A and 2B, showing the variable-height elevated platform in an upper height position and further showing the pivotable bucket in an upped orientation.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

### I. Exemplary Vehicle With Tracks and Variable-Height Elevated Platform

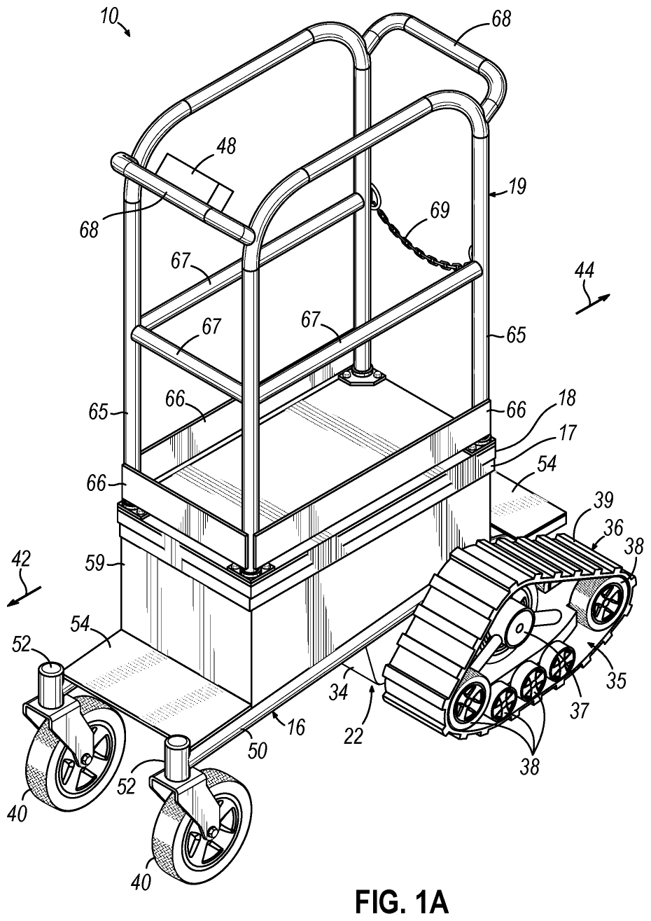

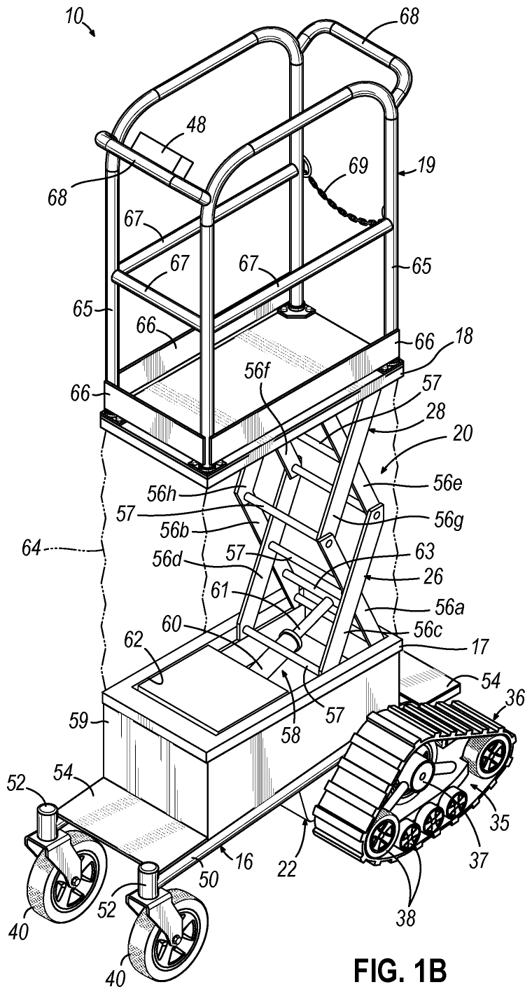

With reference to FIG. 1A and 1B, an exemplary vehicle 10 for tending to agriculture, such as an elevated agriculture including livestock and/or crops (not shown), along an aisle includes a base 16, a lower platform 17, a variable-height elevated platform 18, a guide rail 19 generally surrounding the periphery of the elevated platform 18, an adjustable support frame 20 (FIG. 1B) for varying the height of the elevated platform 18, and a drive unit 22. In the exemplary embodiment shown, the vehicle 10 has an overall width adapted to fit within the aisle of an agricultural facility. For example, the width may be less than 50 inches. More particularly, the width may be between approximately 10 inches and 48 inches, e.g. approximately 19 inches. According to the exemplary embodiment shown in FIGS. 1A and 1B, the support frame 20 has a lower expandable portion 26 and an upper expandable portion 28. The lower portion 26 extends from the lower platform 17 to the upper portion 28, which in turn extends from the lower portion 26 to the elevated platform 18, as described in greater detail below, such that the elevated platform 18 may be selectively positioned at one or more heights above the base 16 suitable to facilitate accessing the elevated agriculture. The height of the elevated platform 18 is generally defined by the distance between the elevated platform 18 and a floor (not shown) on which the vehicle 10 is positioned. The floor may be any surface within the agricultural facility on which the vehicle 10 is capable of traversing. The elevated platform 18 and the support frame 20 are configured to support an operator at the height above the floor 32. In an exemplary embodiment, the height of the elevated platform 18 may be selectively approximately between two inches and approximately fifteen feet. More specifically, the height of the elevated platform 18 may be selectively between approximately four feet and approximately fifteen feet. While the elevated platform 18 is positioned on top of the upper portion 28 as shown in an exemplary embodiment, it will be appreciated that the upper portion 28 and/or the lower portion 26 may be configured in various other ways to position the elevated platform 18 at the desired height.

The drive unit 22 is operatively coupled to the vehicle 10 to selectively move the vehicle 10 about the agricultural facility. As shown in FIGS. 1A and 1B, the drive unit 22 is supported by the base 16. The drive unit 22 includes a drive mechanism 34 and a pair of opposed drive carriages 35 (one shown), each including a respective continuous belt or track 36, a drive hub 37, and a plurality of idler rollers 38. The drive hub 37 mechanically engages the respective track 36 and is operatively coupled to an output (e.g., a shaft) of the drive mechanism 34 such that the drive hub 37 is configured to transfer torque supplied by the drive mechanism 34 to the respective track 36. The tracks 36 are each additionally supported by the respective plurality of idler rollers 38, which may be freely rotatable. The tracks 36 each include an exterior tread 39 configured to provide traction with a floor of the agricultural facility.

A pair of opposed front casters 40 rotatably attach to a front portion of base 16 and the pair of tracks 36 operatively attach to a rear portion of base 16 such that the pair of casters 40 and pair of tracks 36 collectively support the weight of the vehicle 10. The drive mechanism 34 drives, or otherwise propels, the movement of the vehicle 10 forward, as indicated by forward arrow 42, or rearward, as indicated by rearward arrow 44, by applying torque to at least one of the tracks 36 via the respective drive hub 37. More particularly, the drive mechanism 34 includes an electric motor (not shown) to generate torque via at least one of the tracks 36 to drive and steer the vehicle 10. However, it will be appreciated that any known method of moving a vehicle may be used to move the vehicle 10 forward or rearward. In some examples, the drive mechanism 34 may further include a brake mechanism (not shown) and/or a clutch (not shown). Such a brake mechanism and/or clutch may be used in conjunction with the electric motor to steer the vehicle through the aisle, as discussed below.

In other embodiments, the casters 40 and tracks 36 may be provided in any other suitable configuration. For example, the tracks 36 may be operatively attached to the front portion of the base 16 and the casters 40 may be rotatably attached to the rear portion of the base 16. As another example, the tracks 36 may be operatively attached to a middle portion of the base 16 to support the weight of the vehicle 10 independently, such that the casters 40 may be omitted. In other examples, any number of tracks 36 can be attached anywhere along the base 16 to drive the vehicle 10 and any number of casters 40 may be rotatably attached to the base 16 to support the weight of the vehicle.

The vehicle 10 further includes a controller 48 operatively communicating with the drive unit 22, such as via a wiring harness (not shown). More particularly, the controller 48 may be in operative communication with each of the electric motor, brake mechanism, and/or clutch of the drive unit 22. According to the exemplary embodiment, the vehicle 10 includes a pair of non-driven front casters 40, and a pair of driven rear tracks 36. By selectively driving the pair of rear tracks 36 via the controller 48, the operator may selectively direct the tracks 36, and thus maneuver the vehicle 10, along the aisle of the agricultural facility. However, any number of tracks 36 may be driven by the drive mechanism 34 to facilitate moving the vehicle 10. For instance, to improve the ability of the vehicle 10 to move, four tracks 36 may be rotatably attached to the four corners of the base 16 and selectively driven to increase traction within the agricultural facility.

The operator selectively directs the vehicle 10 from atop the elevated platform 18 via the controller 48, which is positioned above the elevated platform 18. The controller 48 may include a joystick (not shown). The operator may selectively manipulate the joystick to turn, or otherwise direct, the vehicle 10 side-to-side while moving forward 42 or rearward 44 by applying torque to one or more tracks 36. In some embodiments, the tracks may each be selectively decoupled from the electric motor, such as via the clutch, and/or may each be selectively fixed against movement, such as via the braking mechanism. For example, the clutch may be configured to selectively decouple the electric motor from one of the tracks 36, and the braking mechanism may be configured to resist that same track 36 from rotating. While this track 36 is decoupled and resisted from rotating, the electric motor may apply torque to the other track to rotatably drive the other track 36 forward 42 or rearward 44. Such coordinated operation between the tracks 36 may turn the vehicle 10. More particularly, one track 36 may be held stationary while the other track 36 may be rotatably driven, thereby propelling the vehicle 10 in an arcuate path about an axis defined by the stationary track 36. Additionally, one track 36 may be rotatably driven forward 42 while the other track 36 may be rotatably driven rearward to turn the vehicle 10 about a central axis defined between the tracks 36, thereby providing a relatively tighter turning radius. It may be advantageous to turn the vehicle 10 with such a tight turning radius when maneuvering in the aisle of an agricultural facility.

In addition, the controller 48 may also include a speed knob, a display, and/or a power key (not shown). The speed knob may be configured to set the forward 42 and/or rearward 44 movement of the vehicle 10 to a speed desired by the operator. The display may provide visual indication to the operator concerning the status of the vehicle 10. For example, the display may provide visual indication of power remaining to propel the vehicle 10. In an exemplary embodiment, the power key is movable between an off position and an on position such that when the power key is either in the off position or removed from the controller 48 entirely, the vehicle 10 is inoperable. However, when the power key is in the on position, the vehicle 10 is operable by the operator. While the controller 48 described herein represents the exemplary embodiment shown in FIGS. 1A and 1B, it will be appreciated that various other displays and features known for driving and steering a vehicle may be used to direct the vehicle 10.

The vehicle 10 may further include a power source (not shown) operatively coupled with the drive unit 22 and the controller 48. According to the exemplary embodiment, the power source may be a battery attached to the vehicle 10. More particularly, the battery may be rechargeable and mounted to the base 16.

In an exemplary embodiment, the base 16 generally includes a base frame 50 and a pair of front swivel joints 52. The base frame 50 is positioned below the lower portion 26 of the support frame 20 and attached to the drive unit 22. More specifically, the drive carriages 35 are each operatively coupled to the base frame 50 adjacent to the drive mechanism 34, which is mounted below the base frame 50. The casters 40 are rotatably mounted to respective front swivel joints 52 about a respective vertical axis, such that the casters 40 are configured to turn for accommodating side-to-side steering of the tracks 36 during use.

As shown in an exemplary embodiment, the base frame 50 is generally planar and fitted with a plurality of protective plates 54, such as aluminum plates, for sufficient durability for use in the agricultural facility. In addition, the base 16, the drive unit 22, and/or the battery are relatively heavy with respect to the remainder of the vehicle 10. Thus, in conjunction with the position of the base 16, the drive unit 22 and/or the battery adjacent to the lower portion 26 of the support frame 20 are sufficiently heavy to inhibit the vehicle 10 from overturning during operation.

As discussed above, the elevated platform 18 is attached to the upper portion 28 of the support frame 20. In an exemplary embodiment, the elevated platform 18 is rectangular in shape, having four corners. However, it will be appreciated that the elevated platform 18 may be other shapes and sizes for accommodating the operator and traversing the aisle. Rather than being fixed relative to the base 16, the elevated platform 18 is adjustable relative to the base 16 to provide a variable height of the elevated platform 18.

With respect to varying the height of the elevated platform 18, in an exemplary embodiment, the support frame 20 includes a plurality of linked, folding support members or arms 56a-h arranged in a crisscross X-shaped pattern to define a pantograph linkage or “scissor” mechanism. In the exemplary embodiment, the arms 56a-h are coupled to each other and/or to the lower and/or elevated platforms 17, 18 by various transverse members 57. More particularly, the support frame 20 includes first and second lower pairs of arms 56a-d having middle portions pivotally coupled to each other to define the lower portion 26, and further includes first and second upper pairs of arms 56e-h having middle portions pivotally coupled to each other to define the upper portion 28. The lower ends of the rearward arm 56a, 56b of each lower pair are fixedly coupled to each other and pivotally coupled to the lower platform 17, while the lower ends of the forward arms 56c, 56d of each lower pair are fixedly coupled to each other and translatably coupled to the lower platform 17 (e.g., along a ledge or groove thereof). The upper ends of the arms 56a-d of each lower pair are pivotally coupled to respective lower ends of corresponding arms 56e-h of the respective upper pair. The upper ends of the forward arms 56e, 56f of each upper pair are fixedly coupled to each other and translatably coupled to the elevated platform 18 (e.g., along a ledge or groove thereof), while the upper ends of the rearward arms 56g, 56h of each upper pair are fixedly coupled to each other and pivotally coupled to the elevated platform 18. Thus, application of pressure to the rearward arms 56a, 56b of the lower portion 26 below their respective pivotable connections to the forward arms 56c, 56d of the lower portion 26 in a generally rearward direction may cause the forward arms 56c, 56d of the lower portion 26 and the forward arms 56e, 56f of the upper portion 28 to translate in a rearward direction relative to the lower and elevated platforms 17, 18, respectively. This action may cause lower and upper portions 26, 28 to each horizontally contract and vertically expand such that the support frame 20 may shorten in the horizontal direction and elongate in the vertical direction to thereby raise the elevated platform 18. While support frame 20 of the present version includes a lower expandable portion 26 and an upper expandable portion 28, support frame 20 may alternatively include any other suitable number of selectively expandable portions for selectively raising and lowering the elevated platform 18, such as a single expandable portion or more than two expandable portions.

To this end, the vehicle 10 further includes an actuator unit 58 contained within a housing 59 between the base frame 50 and the lower platform 17, and configured to selectively apply pressure to the rearward arms 56a, 56b of the lower portion 26 pivotally coupled to the lower platform 17 for transitioning the elevated platform 18 from a lower height position (FIG. 1A) to an upper height position (FIG. 1B). The controller 48 may operatively communicate with the actuator unit 58, such as via a wiring harness (not shown). More particularly, the controller 48 may further include an “up” switch and/or a “down” switch (not shown) in operative communication with the actuator unit 58.

The actuator unit 58 may be provided in the form of a hydraulic actuator including a hydraulic cylinder 60 and a piston rod 61. While not shown, such a hydraulic actuator may further include a motor, a pump, a piping arrangement, a valving arrangement, a reservoir, and an operating fluid configured to cooperate with each other to selectively extend and retract the piston rod 61 relative to the hydraulic cylinder 60. As shown, the lower platform 17 includes an aperture or opening 62 in communication with the interior of the housing 59 for permitting the piston rod 61 and/or hydraulic cylinder 60 to pass therethrough, and the piston rod 61 is pivotally coupled to the rearward arms 56a, 56b of the lower portion 26 via a transverse member 63 fixedly coupled to an end of the piston rod 61. More particularly, the transverse member 63 is pivotally coupled to the rearward arms 56a, 56b of the lower portion 26 below their respective pivotable connections to the forward arms 56c, 56d of the lower portion 26. The actuator unit 58 may alternatively be provided in the form of a mechanical actuator, such as a threaded rod, a rack and pinion, a screw jack, or a bottle jack (not shown) operatively coupled to the rearward arms 56a, 56b of the lower portion 26.

In operation, the up switch of the controller 48 is manipulated to transition the elevated platform 18 from the lower height position to the upper height position. The controller 48 sends a signal via the wiring harness to the actuator unit 58 in response to input provided by the up switch. In response to receiving such a signal, the actuator unit 58 extends the piston rod 61 from the hydraulic cylinder 60 so that the piston rod 61 may apply pressure to the rearward arms 56a, 56b of the lower portion 26 to thereby lift the elevated platform 18. For example, the valving arrangement of the actuator unit 58 may selectively allow fluid communication between the pump and the hydraulic cylinder 60, and the motor of the actuator unit 58 may rotatably drive the pump to draw the operating fluid from the reservoir and thereby increase fluid pressure within the hydraulic cylinder 60. As the fluid pressure within the hydraulic cylinder 60 is increased, the elevated platform 18 transitions from the lower height position to the upper height position. The operator may arrest the extension of the piston rod 61 from the hydraulic cylinder 60 by releasing the up switch, thereby selecting any desired position of the elevated platform 18 between the lower and upper height positions.

In operation, the down switch of the controller 48 is manipulated to transition the elevated platform 18 from the upper height position to the lower height position. The controller 48 sends a signal via the wiring harness to the actuator unit 58 in response to input provided by the down switch. In response to receiving such a signal, the actuator unit 58 retracts the piston rod 61 into the hydraulic cylinder 60 so that the piston rod 61 may release the pressure applied to the rearward arms 56a, 56b of the lower portion 26 to lower the elevated platform 18. For example, the valving arrangement of the actuator unit 58 may selectively allow fluid communication between the hydraulic cylinder 60 and the reservoir to allow the operating fluid to return to the reservoir and thereby decrease fluid pressure within the hydraulic cylinder 60. In this regard, the weight of the elevator platform 18 (and/or of an operator thereon) may apply a downward force upon the arms 56a-h, which may be transferred through the arms 56a-h to the piston rod 61, thereby forcing the operating fluid from the hydraulic cylinder 60 to the reservoir. As the fluid pressure within the hydraulic cylinder 60 is decreased, the elevated platform 18 transitions from the upper height position to the lower height position. The operator may arrest the retraction of the piston rod 61 into the hydraulic cylinder 60 by releasing the down switch, thereby selecting any desired position of the elevated platform 18 between the lower and upper height positions.

While the base 16 and support frame 20 may be formed as described herein, it will be appreciated that various other configurations of the base 16 and the support frame 20 may alternatively be used. Thus, the configuration of the base 16 and the support frame 20 are not intended to be limited to the exemplary embodiments shown and described herein.

The vehicle 10 may also include a waste container and/or a storage container (not shown) to aid the operator tending to the elevated agriculture. In an exemplary embodiment, the waste container may be removably attached to the vehicle 10. A storage container may be attached to the guide rail 19 of vehicle 10 in order to provide the operator with a convenient storage location for tools, parts, or any other items of use to the operator while tending to the elevated agriculture. It will be appreciated that the storage container may alternatively be mounted to various other locations on the vehicle 10.

In order to inhibit objects, such as poultry, from inadvertently contacting the support frame 20 or the actuator unit, the vehicle 10 may include a protective skirt or shroud 64 extending upwardly from the lower platform 17 to the elevated platform 18 to thereby envelope the support frame 20 while also restricting access to the actuator unit 58 within the housing 59. The shroud 64 may include a flexible membrane having an accordion or bellows configuration such that the shroud 64 may selectively compress between the lower platform 17 and the elevated platform 18 when the elevated platform 18 is in the lower height position, and such that the shroud 64 may selectively expand between the lower platform 17 and the elevated platform 18 when the elevated platform 18 is in the upper height position.

The vehicle 10 may also include the guide rail 19 around the elevated platform 18 for bounding the operator on the elevated platform 18. Accordingly, the guide rail 19 includes a pair of opposed side rails 65 and a plurality of lower kick plates 66, middle rails 67 and upper handles 68 extending therebetween. According to this exemplary embodiment, the side rails 65 are rigidly attached to opposing peripheries of the elevated platform 18 and extend upward therefrom. A chain 69 is movably attached to the side rails 65 for allowing the operator to access the elevated platform 18. However, it will be appreciated that any mechanical structure for bounding the operator to the elevated platform 18 may similarly be used.

While the vehicle 10 has been shown and described as having tracks 36, it will be appreciated that the tracks 36 may alternatively be replaced with one or more driven wheels in accordance with one or more teachings of U.S. Pat. No. 9,574,356, entitled “Vehicle and Method for Tending to an Elevated Livestock Cage,” issued Feb. 21, 2017, the disclosure of which is incorporated by reference herein.

### II. Exemplary Vehicle With Tracks and Pivotable Bucket

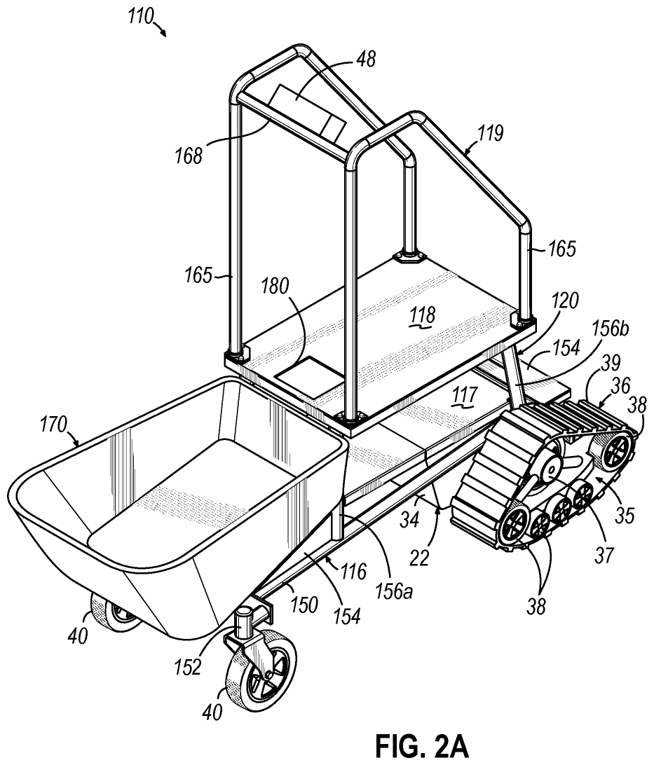

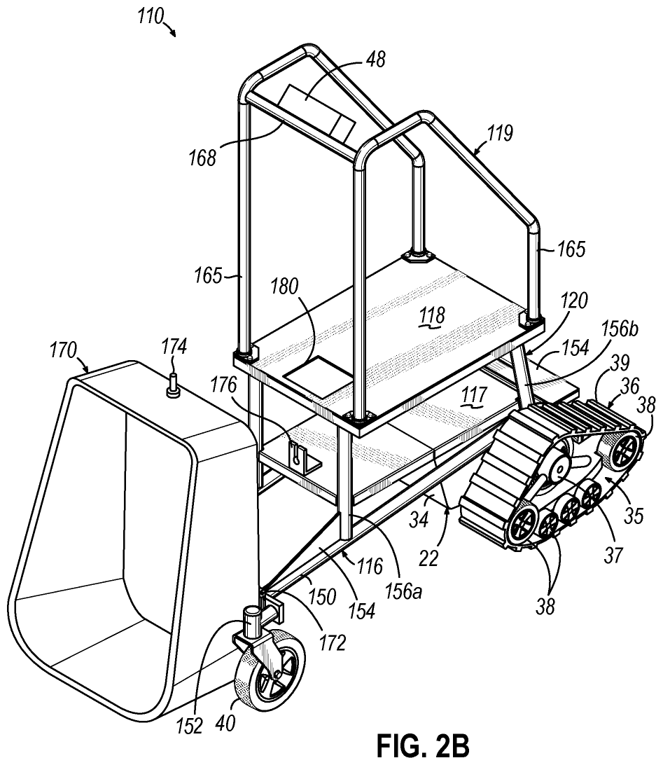

FIGS. 2A and 2B show another exemplary vehicle 110 for tending to agriculture that is substantially similar to the vehicle 10 discussed above except as otherwise described herein. Like the vehicle 10, the vehicle 110 is suitable for tending to agriculture, such as elevated agriculture, including livestock and/or crops. The vehicle 110 is similarly sized (e.g., width-wise) to the vehicle 10 and includes a base 116, a lower platform 117, a fixed-height elevated platform 118, a guide rail 119 generally surrounding the periphery of the elevated platform 118, a fixed support frame 120, the drive unit 22 (including the tracks 36), the casters 40, and the controller 48. In the present example, the elevated platform 118 is fixed relative to the base 16 of the vehicle at a predetermined fixed height relative to the base 116.

In an exemplary embodiment, the base 116 generally includes a base frame 150 and a pair of front swivel joints 152 (one shown). The base frame 150 is positioned below the support frame 120 and attached to the drive unit 22. More specifically, the drive carriages 35 are each operatively coupled to the base frame 150 adjacent to the drive mechanism 34, which is mounted below the base frame 150. The casters 40 are rotatably mounted to respective front swivel joints 152 about a respective vertical axis, such that the casters 40 are configured to turn for accommodating side-to-side steering of the tracks 36 during use.

As shown in an exemplary embodiment, the base frame 150 is generally planar and fitted with a plurality of protective plates 154, such as aluminum plates, for sufficient durability for use in the agricultural facility. In addition, the base 116, the drive unit 22, and/or the battery are relatively heavy with respect to the remainder of the vehicle 10. Thus, in conjunction with the position of the base 116, the drive unit 22 and/or the battery adjacent to the support frame 20 are sufficiently heavy to inhibit the vehicle 110 from overturning during operation.

In an exemplary embodiment, the support frame 120 includes a pair of front support members 156a and a pair of rear support members 156b (one shown) each fixedly attached at one end to the elevated platform 118 and at another end to the base frame 50. Lower platform 17 is horizontally affixed to the support members 156a, 156b between the base frame 50 and the elevated platform 118.

As discussed above, the elevated platform 118 is attached to the support frame 120. In an exemplary embodiment, the elevated platform 118 is rectangular in shape, having four corners. The rectangular elevated platform 118 is rearwardly supported at two of the corners by the pair of rear support members 156b, and is also forwardly supported at the other two of the corners by the pair of front support members 156a. However, it will be appreciated that the elevated platform 118 may be other shapes and sizes for accommodating the operator and traversing the aisle.

According to an exemplary embodiment, the vehicle 110 further includes a waste container in the form of a pivotable bucket 170 to aid the operator tending to the elevated agriculture. More particularly, the bucket 170 may be used for transporting and selectively depositing waste or other objects. For example, the bucket 170 may enable an operator to scoop, transport, and/or deposit waste from the agricultural facility.

As shown, the bucket 170 is pivotally attached to the base 116. More particularly, the bucket 170 is pivotally attached to the front portion of the base 116 forward of the elevated platform 118. As such, the operator may drop waste into the bucket 170 while the operator is positioned on the elevated platform 118. In an exemplary embodiment, the bucket 170 is generally scoop-shaped such that a forward end of the bucket 170 may provide a ramp surface relative to the floor when the bucket 170 is tipped over, as described below, and has a width within the overall width of the remainder of the vehicle 110. However, it will be appreciated that the bucket 170 may be other shapes and sizes for containing waste or other objects and traversing the aisle.

With respect to pivoting the bucket 170, in an exemplary embodiment, the bucket 170 is pivotally attached to the base frame 150 via a hinge plate 172 (FIG. 2B) positioned between the front swivel joints 152, such that the bucket 170 may be selectively pivoted relative to the base frame 150.

To this end, the vehicle 110 may further includes an actuator unit (not shown) between the base frame 150 and the bucket 170, and configured to selectively apply pressure to the bucket 170 for transitioning the bucket 170 from an upped orientation (FIG. 2A) to a dumped orientation (FIG. 2B). In the upped orientation, the bucket 170 is generally upright to maintain contents (e.g., waste) within the bucket 170, and in the dumped orientation, the bucket 170 is generally tipped over to deposit the contents from the bucket 170 and/or to scoop objects into the bucket 170.

The controller 48 may operatively communicate with the actuator unit, such as via a wiring harness (not shown). More particularly, the controller 48 may further include a foot lever (not shown) accessible from the elevated platform 118 and in operative communication with the actuator unit.

The actuator unit may be provided in the form of a hydraulic actuator similar to that described above, such as including a hydraulic cylinder and a piston rod pivotally coupled to the bucket 170. The actuator unit may alternatively be provided in the form of a mechanical actuator, such as a threaded rod, a rack and pinion, a screw jack, or a bottle jack (not shown) operatively coupled to the bucket 170.

In operation, the foot lever of the controller 48 is manipulated in a first direction to transition the bucket 170 from the upped orientation to the dumped orientation. The controller 48 sends a signal via the wiring harness to the actuator unit in response to input provided by the foot lever. In response to receiving such a signal, the actuator unit activates such that the bucket 170 transitions from the upped orientation to the dumped orientation.

In operation, the foot lever of the controller 48 is manipulated in a second direction to transition the bucket 170 from the dumped orientation to the upped orientation. The controller 48 sends a signal via the wiring harness to the actuator unit in response to input provided by the foot lever. In response to receiving such a signal, the actuator unit activates such that the bucket 170 transitions from the dumped orientation to the upped orientation.

In an exemplary embodiment, the vehicle 110 includes a holding mechanism collectively defined by a peg 174 extending rearwardly from the bucket 170 and a slotted bracket 176 (FIG. 2B) positioned on the lower platform 117 and configured to selectively receive the peg 174 when the bucket 170 is in the upped orientation. The slotted bracket 176 may interact with the peg 175 to resist pivoting of the bucket 170 in a first direction from the upped orientation toward the dumped orientation in the absence of a threshold force applied to the bucket 170 to prevent inadvertent dumping of the bucket 170. In addition or alternatively, the slotted bracket 176 may interact with the peg 174 to inhibit pivoting of the bucket 170 in a second direction beyond the upped orientation by providing a stop surface for abutting the peg 174 when the bucket 170 is in the upped orientation.

The vehicle 110 may also include an additional waste container and/or a storage container (not shown) to aid the operator tending to the elevated agriculture. In an exemplary embodiment, the additional waste container may be removably attached to the vehicle 110. In this regard, the elevated platform 118 also includes a waste aperture or passage 180 for disposing waste into the additional waste container. More particularly, the support frame 120 defines a space for receiving the additional waste container on top of the lower platform 117, and the waste passage extends through the elevated platform 118 generally above the space for receiving the additional waste container. As such, the operator may drop waste through the waste passage and into the additional waste container while the operator is positioned on the elevated platform 118. Generally, any waste container sized to be received in the defined space may be used in conjunction with the vehicle 110.

The vehicle 10 may also include the guide rail 119 around the elevated platform 118 for bounding the operator on the elevated platform 118. Accordingly, the guide rail 119 includes a pair of opposed side rails 165 and an upper handle 168 extending therebetween. According to this exemplary embodiment, the side rails 165 are rigidly attached to opposing peripheries of the elevated platform 118 and extend upward therefrom. However, it will be appreciated that any mechanical structure for bounding the operator to the elevated platform 118 may similarly be used.

While the vehicle 110 has been shown and described as having tracks 36, it will be appreciated that the tracks 36 may alternatively be replaced with one or more driven wheels in accordance with one or more teachings of U.S. Pat. No. 9,574,356, entitled “Vehicle and Method for Tending to an Elevated Livestock Cage,” issued Feb. 21, 2017.

### III. Exemplary Vehicle With Tracks, Variable-Height Elevated Platform, and Pivotable Bucket

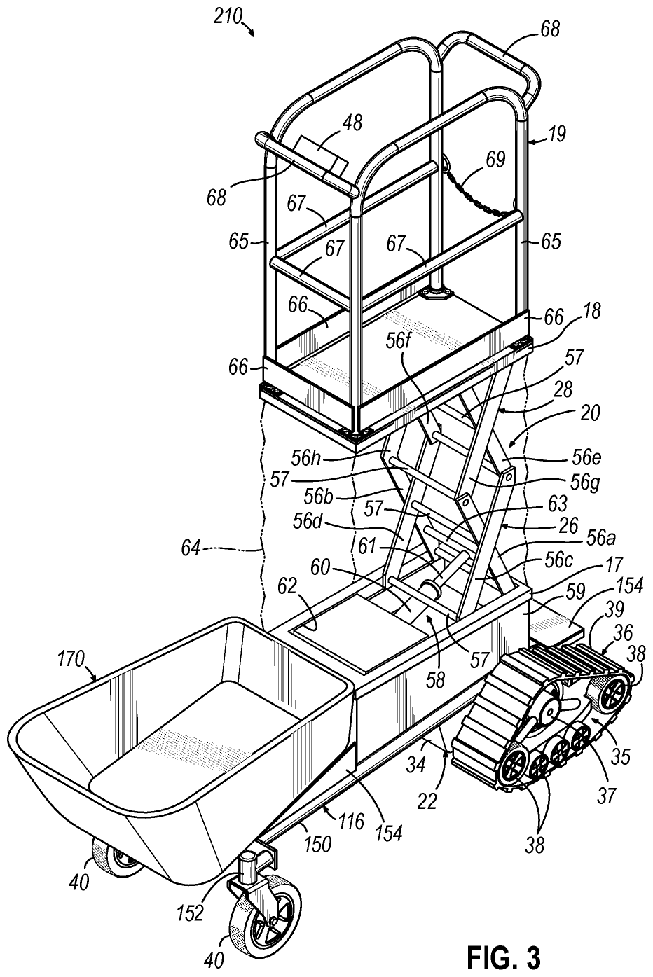

FIG. 3 shows another exemplary vehicle 210 for tending to agriculture that is substantially similar to the vehicles 10, 110 discussed above except as otherwise described herein. Like the vehicles 10, 110, the vehicle 210 is suitable for tending to agriculture, such as elevated agriculture, including livestock and/or crops. The vehicle 210 is similarly sized (e.g., width-wise and height-wise) to the vehicle 10 and similarly sized (e.g., width-wise and length-wise) to the vehicle 110 and includes the base 116, the lower platform 17, the variable-height elevated platform 18, the guide rail 19 generally surrounding the periphery of the elevated platform 18, the adjustable support frame 20, the drive unit 22 (including the tracks 36), the casters 40, the controller 48, the actuator unit 58, and the pivotable bucket 170. Thus, the vehicle 210 incorporates both the variable-height elevated platform 18 of the vehicle 10 and the pivotable bucket 170 of the vehicle 110. In this regard, FIG. 3 shows the elevated platform 18 in the upper height position and the pivotable bucket 170 in the upped orientation. It will be appreciated that the elevated platform 18 may be selectively transitioned to the lower height position (see FIG. 1A) and that the pivotable bucket 170 may be selectively transitioned to the dumped orientation (see FIG. 2B), as described above with respect to the vehicles 10, 110, respectively.

While the vehicle 210 has been shown and described as having tracks 36, it will be appreciated that the tracks 36 may alternatively be replaced with one or more driven wheels in accordance with one or more teachings of U.S. Pat. No. 9,574,356, entitled “Vehicle and Method for Tending to an Elevated Livestock Cage,” issued Feb. 21, 2017.

### IV. Exemplary Method of Tending to Agriculture

In use, an operator tends to an elevated agriculture, which may include a plurality of elevated livestock cages and/or crop layers, with any of the vehicles 10, 110, 210 described above being disposed within an aisle of the agricultural facility, such as a confinement facility and/or horticultural facility. However, the following will describe the use of the third embodiment of the vehicle 210 shown in FIG. 3. As such, the operator ascends onto the variable-height elevated platform 18, which supports the operator at an adjustable position and height from which the operator may access at least any one of the plurality of elevated livestock cages and/or crop layers. The operator powers the drive unit 22 and actuates the vehicle 310 to position the vehicle 310 and the operator adjacent to at least one of the plurality of elevated livestock cages and/or crop layers. Actuating the vehicle 310 may further include driving, steering, and stopping the vehicle 310 along the aisle adjacent to the plurality of elevated livestock cages and/or crop layers.

From a position on the elevated platform 18, the operator may inspect at least one of the plurality of elevated livestock cages and/or crop layers. After inspection, the operator may further access at least one of the plurality of elevated livestock cages and/or crop layers in order to perform maintenance or collect waste from within the elevated livestock cage and/or crop layer. In the case of performing maintenance, the operator may remove and/or replace tools from within the storage container while maintaining the elevated livestock cage and/or crop layer. The operator may also collect waste and place the waste within the pivotable bucket 170, which may include placing the pivotable bucket 170 in the dumped orientation for scooping waste into the pivotable bucket 170. Following inspection, maintenance, or waste collection, the operator may observe at least another of the plurality of elevated livestock cages and/or crop layers and move the vehicle 310 along the aisle with the plurality of elevated livestock cages and/or crop layers. Generally, the operator may repeat this method for tending to the elevated livestock cage and/or crop layer for each of the plurality of elevated livestock cages and/or crop layers within the agricultural facility. It will be appreciated that the operator may vary the height of the elevated platform 18 in order to improve access to elevated livestock cages and/or crop layers at various heights from the floor of the agricultural facility. Following waste collection, the operator may move the vehicle 310 to an exterior of the agricultural facility to transport the waste within the pivotable bucket 170 from the agricultural facility to a compost pile, and may place the pivotable bucket 170 in the dumped orientation to deposit the waste from the pivotable bucket 170 onto the compost pile.

### V. Miscellaneous

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/we claim:

1. A vehicle for tending to an elevated agriculture within an agriculture facility, comprising:
a base horizontally extending from a forward base portion to a rearward base portion;
a lower platform positioned vertically above the base and fixed thereto;
an adjustable support frame extending vertically upward from the lower platform, wherein the adjustable support frame includes at least one expandable scissor portion;
an elevated platform connected to the adjustable support frame such that the elevated platform is positioned vertically above the lower platform and horizontally between the forward and rearward base portions, the elevated platform configured to selectively, vertically raise upward relative to the base from a lower position toward a higher position via selective expansion of the at least one expandable scissor portion of the adjustable support frame;
a guide rail extending vertically upward from the elevated platform and horizontally surrounding at least a portion of the elevated platform for bounding an operator atop the elevated platform; and
a drive unit operatively attached to the base and configured to selectively direct horizontal movement of the base with the elevated platform thereon for supporting the operator on the elevated platform while moving the elevated platform within the agriculture facility.

2. The vehicle of claim 1, wherein the at least one expandable scissor portion includes first and second arms pivotally coupled to each other at respective middle portions thereof, wherein the first arm is pivotally coupled to the lower platform, wherein the second arm is translatably coupled to the lower platform.

3. The vehicle of claim 1, wherein the at least one expandable scissor portion includes first and second arms pivotally coupled to each other at respective middle portions thereof, wherein the first arm is pivotally coupled to the elevated platform, wherein the second arm is translatably coupled to the elevated platform.

4. The vehicle of claim 1, wherein the at least one expandable scissor portion includes an upper expandable scissor portion and a lower expandable scissor portion.

5. The vehicle of claim 4, wherein the lower expandable scissor portion includes first and second arms pivotally coupled to each other at respective middle portions thereof, wherein the first arm is pivotally coupled to the lower platform, wherein the second arm is translatably coupled to the lower platform.

6. The vehicle of claim 5, wherein the upper expandable scissor portion includes third and fourth arms pivotally coupled to each other at respective middle portions thereof, wherein the third arm is pivotally coupled to the elevated platform, wherein the fourth arm is translatably coupled to the elevated platform.

7. The vehicle of claim 6, wherein the first and second arms are pivotally coupled to the third and fourth arms, respectively.

8. The vehicle of claim 1, further comprising a controller operatively connected to the drive unit and positioned vertically above the elevated platform, wherein the controller is configured to be manipulated by the operator and thereby selectively direct horizontal movement of the base with the elevated platform thereon.

9. The vehicle of claim 1, wherein the drive unit includes at least one drive carriage connected to the base such that the at least one drive carriage extends downward from the base for supporting the base thereon, wherein the at least one drive carriage includes at least one track configured to move relative to the base for driving movement of the base within the agricultural facility.

10. The vehicle of claim 9, further comprising at least one caster connected to the base such that the at least one caster extends downwardly from the base for supporting the base thereon.

11. The vehicle of claim 1, further comprising an actuator unit positioned between the elevated platform and the base, wherein the actuator unit is configured to drive upward movement of the elevated platform from the lower position toward the higher position.

12. The vehicle of claim 11, wherein the actuator unit includes a hydraulic actuator.

13. The vehicle of claim 1, further comprising a bucket pivotally coupled to the base, the bucket configured to selectively pivot relative to the base from an upped orientation toward a dumped orientation.

14. The vehicle of claim 13, wherein the bucket is pivotally coupled to the forward base portion of the base.

15. The vehicle of claim 14, wherein the bucket is positioned horizontally forward of the elevated platform.

16. A vehicle for tending to an elevated agriculture within an agriculture facility, comprising:
a base horizontally extending from a forward base portion to a rearward base portion;
a lower platform positioned vertically above the base and fixed thereto;
at least one expandable scissor portion extending vertically upward from the lower platform;
an elevated platform connected to the at least one expandable scissor portion such that the elevated platform is positioned vertically above the lower platform and horizontally between the forward and rearward base portions, the elevated platform configured to selectively, vertically raise upward relative to the base from a lower position toward a higher position via selective expansion of the at least one expandable scissor portion;
a guide rail extending vertically upward from the elevated platform and horizontally surrounding at least a portion of the elevated platform for bounding an operator atop the elevated platform;
a drive unit operatively attached to the base and configured to selectively direct horizontal movement of the base with the elevated platform thereon for supporting the operator on the elevated platform while moving the elevated platform within the agriculture facility;
a first actuator unit positioned between the elevated platform and the base, wherein the first actuator unit is configured to drive upward movement of the elevated platform from the lower position toward the higher position; and
a controller operatively connected to each of the drive unit and the first actuator unit and positioned vertically above the elevated platform, wherein the controller is configured to be manipulated by the operator for selectively directing horizontal movement of the base with the elevated platform thereon and for selectively transitioning the elevated platform between the lower and higher positions.

17. The vehicle of claim 16, further comprising a bucket pivotally coupled to the base, the bucket configured to selectively pivot relative to the base from an upped orientation toward a dumped orientation.

18. The vehicle of claim 17, further comprising a second actuator unit positioned between the bucket and the base, wherein the second actuator unit is configured to drive pivoting of the bucket from the upped orientation toward the dumped orientation.

19. The vehicle of claim 18, wherein the controller is operatively connected to the second actuator unit, wherein the controller is configured to be manipulated by the operator for selectively transitioning the bucket between the upped and dumped orientations.

20. A method of tending to an elevated agriculture within an agriculture facility with a vehicle, wherein the vehicle includes a base; a lower platform positioned vertically above the base; at least one expandable scissor portion extending vertically upward from the lower platform; an elevated platform connected to the at least one expandable scissor portion such that the elevated platform is positioned vertically above the base; and a drive unit operatively attached to the base, the method comprising:
supporting an operator on the elevated platform;
selectively directing horizontal movement of the base with the elevated platform thereon via the drive unit in order to move the operator atop the elevated platform within the agriculture facility; and
vertically expanding the at least one expandable scissor portion to lift the elevated platform from the lower position toward the higher position in order to move the operator atop the elevated platform upward within the agriculture facility such that the operator accesses and tends to the elevated agriculture above a floor of the agriculture facility from atop the elevated platform.
